(19) United States
(12) Patent Application Publication
(10) Pub. No.: US 2026/0280664 A1
(43) Pub. Date: Sep. 17, 2026

(54) BEAM SCHEDULING FOR NETWORK-CONTROLLED REPEATERS

(71) Applicant: Apple Inc., Cupertino, CA (US)

(72) Inventors: Ankit Bhamri, Haar (DE); Dan Wu, Beijing (CN); Hong He, San Jose, CA (US); Chunxuan Ye, San Diego, CA (US); Wei Zeng, Saratoga, CA (US); Oghenekome Oteri, San Diego, CA (US); Huaning Niu, San Jose, CA (US); Dawei Zhang, Saratoga, CA (US); Haitong Sun, Saratoga, CA (US)

(73) Assignee: Apple Inc., Cupertino, CA (US)

(21) Appl. No.: 19/156,863

(22) PCT Filed: Feb. 15, 2023
(86) PCT No.: PCT/CN2023/076209

§ 371 Date: Aug. 14, 2025

(51) Int. Cl. H04B 7/06; H04B 7/0456; H04B 7/10; H04B 7/15

(52) U.S. Cl. CPC H04B 7/06952; H04B 7/0456; H04B 7/10; H04B 7/15

(57) ABSTRACT

The present application relates to devices and components, including apparatus, systems, and methods for allocating time domain resources to transmission beams at a network-controlled repeater.

### TECHNICAL FIELD

This application generally relates to cellular communication networks and, in particular, to technologies for forwarding information using network-controlled repeaters.

### BACKGROUND

Cellular communication networks deploy repeaters to improve coverage or support more users. Network-controlled repeaters (NCR) are considered at Third Generation Partnership Project (3GPP) standardization as an in-band amplify-and-forward repeater. NCRs are transparent to the user equipment (UE) and under the network operator's control. Efficient allocation of network resources by the NCRs is desired.

### BRIEF DESCRIPTION OF THE DRAWINGS

FIG. 1 illustrates a network environment in accordance with some embodiments

FIG. 2 illustrates a timing diagram in accordance with some embodiments

FIG. 3 illustrates a timing diagram in accordance with some embodiments

FIG. 4 illustrates a timing diagram in accordance with some embodiments

FIG. 5 illustrates a block diagram in accordance with some embodiments

FIG. 6 illustrates a block diagram in accordance with some embodiments

FIG. 7 illustrates an operational flow/algorithmic structure in accordance with some embodiments

FIG. 8 illustrates an operational flow/algorithmic structure in accordance with some embodiments

FIG. 9 illustrates an operational flow/algorithmic structure in accordance with some embodiments

FIG. 10 illustrates a network node in accordance with some embodiments

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, or techniques, to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B), and the phrase “based on A” means “based at least in part on A,” for example, it could be “based solely on A,” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group), or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer to an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry,” as used herein, refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to and may be referred to as client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to a computer, storage, or network resources provided by physical hardware element(s). A “virtualized resource” may refer to a computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any tangible or intangible transmission medium used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like, as used herein, refer to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

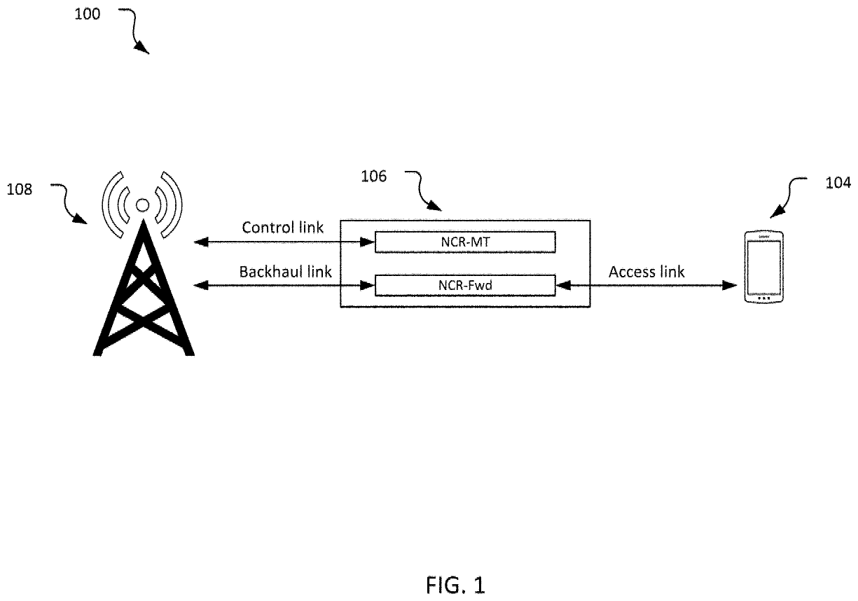

FIG. 1 illustrates a network environment 100 in accordance with some embodiments. The network environment 100 may include the UE 104, the base station (BS) 108, and the network-controlled repeater (NCR) 106. The UE 104 is coupled with the network-controlled repeater (NCR) 106, and the NCR 106 is coupled with the base station (BS) 108 of a radio access network (RAN). In some embodiments, the UE 104 may be coupled with the BS 108 and the NCR 106.

In some embodiments, the BS 108 may be a next-generation node B (gNB) that provides one or more 3GPP New Radio (NR) cells, an evolved node B (eNB) that provides one or more Long Term Evolution (LTE) cells, or another type of BS that provides a later-generation, e.g., a Sixth Generation (6G) serving cell. The air interface over which the UE 104 and the BS 108 communicate may be compatible with 3GPP technical specifications (TSs), such as those that define 5G NR or later system standards (e.g., 6G standards).

The NCR 106 may include NCR-Fwd (forwarding) functional entity. When operating as NCR-Fwd, the NCR 106 may receive radio frequency (RF) signals from the BS 108 on the backhaul link, where the signals are intended to be received by the UE 104. The NCR 106 receives the RF signals from the BS 108 on the backhaul link, amplifies them, and forwards them to the UE 104 through the access link. The RF signals that NCR 106 receives may include data, control, or reference signals. Similarly, in the uplink, when the UE 104 sends signals to the BS 108, the NCR 106 may receive the RF transmissions from the UE 104 on the access link. The NCR 106 then amplifies and forwards the signals from the UE 104 and sends them to the BS 108 on the backhaul link.

The NCR 106 may include NCR-MT (mobile termination) functional entity. When operating as NCR-MT, the NCR 106 has a subset of a UE's functionality. For example, the NCR 106 receives control signaling on the control link from the BS 108 to configure the operation of the NCR 106. The NCR 106 may be configured by radio resource control (RRC) signaling or by the operation, administration, and management (OAM) aspect of the self-organizing network (SON). In some instances, the NCR 106 receives side control information (SCI) for controlling and configuring the NCR 106 transmission or reception on the access link.

In some instances, the BS 108 may configure periodic beams at the NCR 106. For each periodic beam indication for the access link, one RRC signaling is used. The RRC signaling includes a list of X (1≤X≤Xₘₐₓ) forwarding resources. Each forwarding resource is defined as a pair of a beam index and a time resource, e.g., {beam index, time resource}.

The time resource of the forwarding resource includes a starting slot defined as the slot offset in one period, a starting symbol defined by the symbol offset within the slot, and a duration defined by the number of symbols with a dedicated field, e.g., {starting slot, starting symbol, duration}. The periodicity is configured as part of the RRC signaling for periodic beam indication. In one embodiment, the same periodicity may be assumed for all time resources in one periodic beam indication. The reference subcarrier spacing (SCS) may be configured as part of the RRC signaling for periodic beam indication. The same reference SCS may be assumed for all time resources in one periodic beam indication.

In some instances, the BS 108 may configure aperiodic beams at the NCR 106. The BS 108 may use one downlink control information (DCI) for each aperiodic beam indication for the access link. For example, the DCI may include Lₘₐₓ fields to indicate the beam information, and each field refers to one beam index. The bit-width of the field may depend on the number of beams used for the access link.

The DCI may also include Tₘₐₓ fields to indicate the time resources. The BS 108 may preconfigure the NCR 106 with a list of time resources. For example, the BS 108 may configure a list of time resources at the NCR 106 by RRC signaling. The bit-width of the field for time resource indication may depend on the length of the list. Each time resource may include a starting slot defined as the slot offset, a starting symbol defined by offset within the slot, and a duration defined by the number of symbols, with the dedicated field, e.g., {starting slot, starting symbol, duration}.

It is desired to reduce the resources allocated for the indicating time resources, e.g., Tₘₐₓ=1. When a single time-domain resource field is signaled and multiple beam indices are indicated, defining an association between the time-domain resources and corresponding beams for the access link is required.

In another embodiment, for specific frequencies, e.g., frequency range 1 (FR1) that includes frequencies below approximately 7.125 GHz, the BS 108 may indicate the ON state for NCR-Fwd. When in the ON state, the NCR-Fwd functionality of the NCR 106 is enabled, and the NCR 106 may forward the transmissions from the BS 108 to the UE 104. The BS 108 may indicate the ON state to the NCR 106 via the beam indication. For example, when the NCR 106 receives a beam indication from the BS 108, the NCR 106 may assume to be ON over the indicated time domain resources associated with corresponding beams. In one embodiment, when the BS 108 only indicates one beam, the sole purpose of the beam indication may be to indicate the ON state of the NCR-Fwd.

In another embodiment, the NCR 106 may receive periodic, semi-persistent, and aperiodic beam indications. It is desired to follow a rule for prioritizing the beam indication to resolve any potential conflicting beam scheduling. There may be three options. In option 1, the BS 108 is required to configure periodic, semi-persistent, and aperiodic beam indications so that no conflict is expected on the beam indication from different types of beam indications. In option 2, if there is a conflict among beam indications from different types of indications, the order of priority is defined as an aperiodic beam, a semi-persistent beam indication, and a periodic beam. Option 2 implies that if there is an aperiodic beam indication and a conflict, it determines the beam and time resources. In the absence of an aperiodic beam indication, if there is a conflict, a semi-persistent beam indication determines the beam and associated time resources. In option 3, if there is a conflict among beam indications from different types of indicators, the order of priority is defined as periodic beam indication, aperiodic beam indication, and then semi-persistent beam indication.

In what follows, detailed aspects of the association between time-domain resources and corresponding beams for the access link, determination of the ON state based on the beam indicator, and prioritization between semi-persistent and aperiodic signaling of side control information are disclosed.

The NCR 106 may be configured (e.g., via RRC or OAM) with a set of beams for forwarding on the access link. In some instances, the BS 108 may set one beam as the default beam. In addition, the BS 108 may associate each beam with a beam index. For example, to configure the NCR 106 to use a specific beam for forwarding on the access link, the BS 108 may send a message, e.g., an SCI or a message including SCI, to the NCR 106, including the beam index associated with the specific beam. The BS 108 may configure the forwarding transmissions on the access link by instructing the NCR 106 to use a beam specified by the BS 108 at a transmission time specified by the BS 108.

In some embodiments, the network configures and divides transmissions into radio frames. For example, a radio frame could last 10 milliseconds (ms). The network keeps track of radio frames and determines and configures the beginning or end of each radio frame.

The network also provides signaling for synchronization and timing for the UEs and NCRs. The network may further divide the radio frame into subframes or slots. For example, a radio frame may include ten slots, each 1 ms long. The network may further divide each slot into symbols, for example, 14 symbols per slot. The BS 108 schedules and allocate time resources, e.g., slots or symbols within a radio frame, to a transmitter, e.g., a UE, BS, or NCR, for transmission of data, control, or reference signals.

The BS 108 may configure the NCR 106 with a beam and time resource indication for forwarding signals to the UE 104. The NCR 106 may infer from the beam indication the beam that the NCR 106 starts using for forwarding to the UE 104 at the time indicated by the time resource indication. The NCR 106 may infer from the time resource indication the transmission time within a radio frame. For example, the time resource indication may determine the slot within the radio frame and the symbol within that slot at which the NCR 106 start using the beam determined by beam indication for transmitting the forwarding signals to the UE 104 on the access link.

In one instance, the time resource indication may include or may indirectly point to preconfigured time resources that may include a slot offset, a symbol offset, or a duration. The NCR 106 may start using a beam at the starting time, determined by the time resource indication, for a period that is at least equal to the parameter duration determined by the time resource indication. In one instance, the NCR 106 determines the start time based on the slot offset or the symbol offset. The start time is when the NCR 106 starts using a beam for forwarding on the access link. The slot offset may represent the slot number of a radio frame. The duration may determine the period that the NCR 106 continues to use the beam.

For example, in a radio frame with ten slots, the slots may be associated with indexes 0 to 9, e.g., the first slot in a radio frame has slot number 0, and the tenth slot in the radio frame has slot number 9. The slot offset of 0 may represent the first slot of the radio frame. Similarly, the symbol offset may represent the symbol number within a slot. For example, in a slot with 14 symbols, the symbols may be indexed by numbers 0-13. A symbol offset 7 is the eighth symbol in the slot.

In some instances, the forwarding time is the number of slots from the slot in which the NCR 106 receives the time resource indication. For example, if the NCR 106 receives the time resource indication in slot n of the radio frame and the slot offset has the value k, the slot of the starting time is n+k.

The BS 108 may configure periodic beams for the access link. The BS 108 sends the beam and time resource indications to the NCR 106. The NCR computes and determines the starting time for using the beam in the radio frame in which the NCR 106 receives the configuration message from the BS 108. The BS 108 may also configure the periodicity of using the beam. For example, the NCR 106 determines that the starting time is the slot m of the radio frame. In one implementation, the BS 108 may configure the NCR 106 to use the beam indicated by the beam indicator at the slot number m of every radio frame. In another implementation, the BS 108 may configure the NCR 106 with a periodicity that has the value l. The NCR 106 first start using the beam at slot m and every other l slot after that, e.g., slots m, m+l, m+2l, m+3l, and so on. In one example, the slot offset determines the starting slot in a period instead of in a radio frame.

The BS 108 may configure more than one beam. For example, the BS 108 may configure a list of X forwarding resources, each forwarding resource including a beam index and a time resource, where the beam index determines the beam and the time resource determines the starting time and duration of using the beam. The BS 108 may use RRC signaling to configure the forwarding resources. For example, the BS 108 may configure the periodicity as part of the RRC signaling for periodic beam configuration. In one instance, the same periodicity applies to all configured periodic beams.

The BS 108 may configure aperiodic beams for the access link. Aperiodic configuration is dynamic, and the BS 108 may change the configuration faster and with less signaling overhead than the periodic configuration. For example, the BS 108 may configure the NCR 106 using downlink control information (DCI). The Bs 108 may send the DCI on the control link to NCR 106 to configure the beams at the NCR 106. The BS 108 may use side control information (SCI) to configure aperiodic beams at the NCR 106.

In one instance, the DCI, e.g., the SCI included in the DCI, may include fields to indicate the beam information and field to indicate the time resources. For example, the BS 108 may use the Lₘₐₓ field to indicate the beam information. Each field may refer to one beam index, and each beam index is associated with a configured beam at the NCR 106. The number of bits allocated for each field depends on the total number of configured beams for the access link.

The BS 108 may use the Tₘₐₓ field to indicate the time resources. The BS may configure the NCR 106 with a list of time resources using RRC signaling. Each field indicates a time resource in the preconfigured list. The number of bits allocated to each field depends on the number of configured time resources. The time resources may include the slot offset, symbol offset, and duration, where the symbol offset defines the symbol in a slot, and the duration is in the number of symbols. When Tₘₐₓ=Lₘₐₓ, a one-to-one association between the time resources and beam indexes may determine the starting time and duration of each beam indicated by the beam information field. However, for Tₘₐₓ=1 and Lₘₐₓ>1, a different association between the time resource and beams is needed.

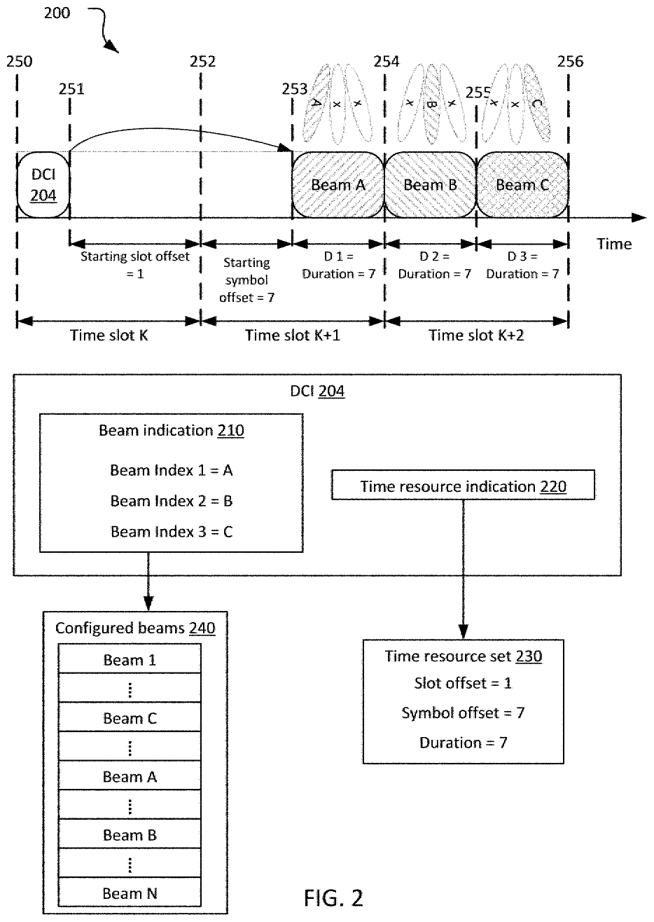

FIG. 2 illustrates a timing diagram 200 in accordance with some embodiments. Timing diagram 200 is an example of the association of three beams to a single time resource, in which all beams have the same transmission duration equal to the duration of the time resource set 330.

At 250, which is in slot K, the BS sends, and the NCR receives the DCI 204. The DCI 204 includes the beam indication 210 and time resource indication 220.

The beam indication 210 includes three beam index fields: beam index 1 with value A, beam index 2 with value B, and beam index 3 with value C. Each beam index is associated with a beam in the configured beam 240. The BS configures N beams at the NCR to be used for forwarding transmission to the UE on the access link. For example, beam index 1 is associated with beam A, beam index 2 is associated with beam B, and beam index 3 is associated with beam C.

The time resource indication 220 indicates the time resource set 230. The BS configures the NCR with the time resource set. The time resource set 230 may include a slot offset measured in slots, a symbol offset measured in symbols, or a duration measured in symbols. For example, in time resource set 230, the slot offset is 1 slot, the symbol offset is 7 symbols, and the duration is 7 symbols.

At 251, the transmission of the DCI 204 ends, and the NCR successfully decodes the DCI 204 and determines the beam indication 210 and time resource indication 220.

At 252, slot K ends, and slot K+1 begins. Each slot includes 14 symbols. At 254, slot K+1 ends, and slot K+2 begins. Time marker 256 shows the end of slot K+2.

The NCR determines the starting time of the first beam index based on the indicated slot offset and the symbol offset of the time resource set 230. The NCR determines the starting time of the following beam indices (other than the first beam index) based on the consecutive sequence of beams. For example, the second beam starting time begins when the duration of the first beam ends. The NCR may use the second beam for the transmission duration of the second beam. The third beam starting time begins when the duration of the second beam ends, and so on.

The NCR may order the beams based on the order in which they are received in the beam indication 210. For example, beam A, associated with beam index 1, is the first beam, beam B, associated with beam index 2, is the second beam, and beam C, associated with the beam index 3, is the third beam.

Based on the value of slot offset (slot offset=1), the NCR determines that the first beam starting time is in slot K+1 (slot K in which SCI is received+1 (value of the slot offset)). Moreover, the NCR determines the starting time within the slot based on the symbol offset. For example, the NCR determines that the first beam starting time is at the 7th symbol of the slot K+1, e.g., at 253, based on the value of symbol offset in time resource set 230 is 7 symbol. The NCR may determine the starting time of subsequent beams and the duration of each beam.

The NCR may determine the transmission duration for each beam based on the configured duration in the time resource set 230. In one instance, the NCR may set the transmission duration of each beam to be the same as the duration in the time resource set 230. The same indicated duration in the time resource indication is applied for all the beam indices. Therefore, the total time duration of all the beam indices will be the number of indicated beam indices times the indicated duration in the time resource. For example, the transmission duration using beams A, B, and C are all the same and equal to 7 symbols, as the duration in time resource set 230 is 7 symbols.

The NCR determines the starting time of beam B based on the starting time of beam A, at 253, and the duration of beam A, e.g., 7 symbols, to be at 254. At 254, the NCR may start using beam B for a transmission duration of 7 symbols.

At 255, the transmission duration of beam B ends, and the NCR may start using beam C for a transmission duration of 7 symbols.

In this example, the DCI 204 configures the NCR to use beam A between time marks 253 and 254, beam B between time markers 254 and 255, and beam C between time markers 255 and 256 for forwarding transmissions from the BS to the UE. If the NCR does not have any transmission to forward between 253 and 254, the NCR may not transmit signals via beam A. Similarly, if the NCR does not receive any transmission to be forwarded to the UE between the time markers 254 and 255, the NCR does not make any transmission using the beam B.

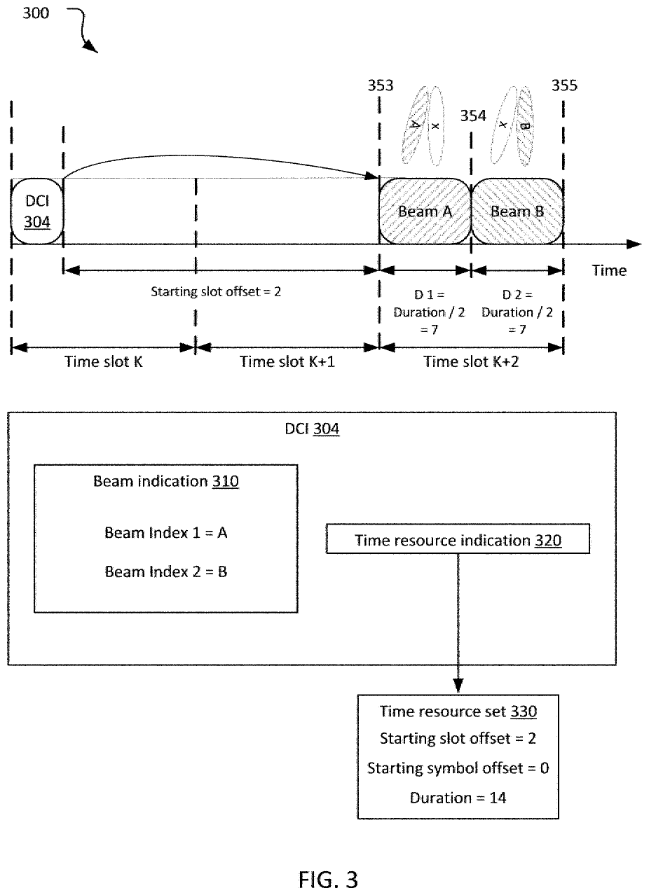

FIG. 3 illustrates a timing diagram 300 in accordance with some embodiments. Timing diagram 300 is an example of the association of two beams to a single time resource. Both beams have the same transmission duration, and the sum of the beams' transmission duration equals the duration of the time resource set 330.

Many aspects of FIG. 3 is similar to FIG. 2. The NCR receives and decodes the DCI 304. The NCR determines beams A and B based on the beam indication 310. The NCR determines the time resource set 330 based on the time resource indication 320. The NCR determines the starting time of beam A, e.g., at time marker 353, based on the starting slot offset (value 2 slots) and starting symbol offset (value 0 symbols) of time resource set 330. The NCR then determines the starting time of beam B, at time marker 354, based on the starting time of beam A and the transmission duration of beam A. The starting time of the following beam indices, the starting time is determined based on the consecutive sequence of beams. The starting time of beam B is when the transmission duration of beam A ends. The main difference between the example illustrated in FIG. 2 and FIG. 3 is in determining and computing the transmission duration associated with each beam.

In the example illustrated by FIG. 3, the NCR equally divides the duration of 14 symbols configured by the time resource set 330 between beams A and B. Each beam has a transmission duration of 7 symbols. At 353, the NCR may start using beam A for a duration of 7 symbols. At 354, the transmission duration of beam A ends, and the NCR may start using beam B for a duration of 7 symbols.

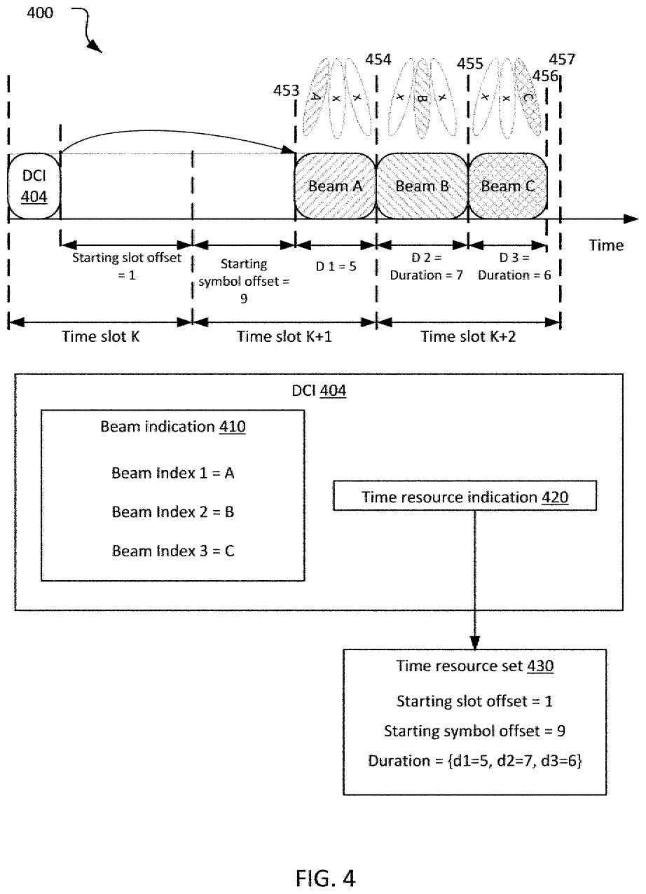

FIG. 4 illustrates a timing diagram 400 in accordance with some embodiments. Timing diagram 400 is an example of the association of three beams to a single time resource. The time resource 430 specifies the duration for each beam. The duration of each beam is determined by one-to-one mapping with the durations indicated by the time resource 430. In general, if there are Lₘₐₓ beams indicated by the beam indication 410, there time resource 430 also includes Lₘₐₓ durations. A preconfigured mapping associated each beam selected by beam indication 410 to a duration in the time resource 430.

Many aspects of FIG. 4 are similar to FIG. 2 or FIG. 3. The NCR receives and decodes the DCI 404. The NCR determines beams A, B, and C based on the beam indication 410. The NCR determines the time resource set 430 based on the time resource indication 420. The NCR determines the starting time of beam A, e.g., at time marker 453, based on the starting slot offset (2 slots) and starting symbol offset (9 symbols) of time resource set 430.

The duration field in time resource set 430 includes three transmission durations, and the NCR associates beam A, B, and C with a transmission duration. For example, the transmission durations of beams A, B, and Care d1=5, d2=7 symbols, and d3=6 symbols, respectively. The NCR determines the starting time of beam B, at time marker 454, based on the starting time of beam A and the transmission duration of beam A (d1=5 symbols). Furthermore, the NCR determines the starting time of beam C, at time marker 455, based on the starting time of beam B and the transmission duration of beam B (d2=7 symbols).

A beam's starting time need not be aligned with the beginning or middle of a slot. The transmission duration associated with a beam may be any number of symbols. For example, the transmission duration may be equivalent to half of a slot, one slot, or more than one slot (e.g., 20 symbols).

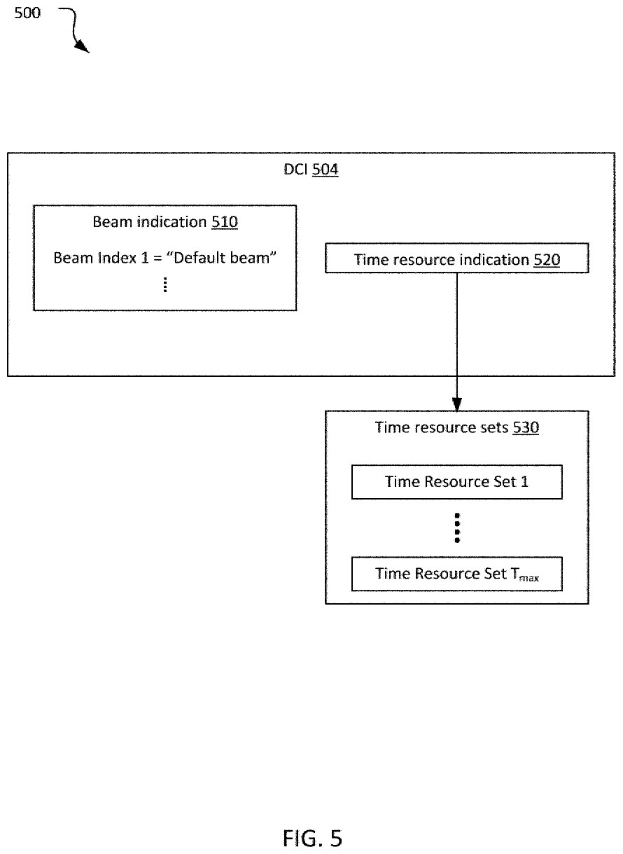

FIG. 5 illustrates a block diagram 500 in accordance with some embodiments. Block diagram 500 is an example of the SCI 504, including a default beam. The BS configures the NCR with a default beam, and the beam index 1 of the beam indication 510 points to the preconfigured default beam. The time resource indication 520 identifies the time resource sets 530. Time resource sets 530 may include time resource sets 1-Tₘₐₓ. Each time resource set may include a slot offset, symbol offset, and duration that can determine the starting time and transmission duration for a configured beam.

The BS may configure the default beam semi-statically via RRC configuration. The default beam may be configured statically, e.g., during deployment. The default beam index may be the lowest beam index, e.g., index 0. In some instances, when the beam indication 510 indicates the preconfigured default beam, NCR may determine that the beam index of the default beam in the beam indication 510 is used for ON indication for NCR-Fwd. The NCR may use the default or omnidirectional beam for transmissions on the access link. The beam indication 510 may only include the beam index of the default beam. The beam indication 510 may include the default beam index and the index or indexes of other configured beams. In one instance, the SCI 504 may include the beam indication 510 with only the beam index of the default beam and without any time resource indication.

In one instance, the SCI 504 may include the beam indication 510 with only the beam index and the time resource indication 520, indicating a time resource sets 530 with more than one resource set, e.g., Tₘₐₓ>1. The NCR may interpret the beam indication of the default beam as an ON indication for NCR-Fwd, and the time resource set determines when to turn ON the NCR-Fwd. For example, the slot and symbol offset of the time resource sets 530 determines the starting time of activating or turning on the NCR-Fwd, and the duration of the time resource sets 530 determines the period during which the NCR-Fwd remains ON. The NCR-Fwd ON time need not be contiguous. The ON periods of the NCR-Fwd may be contiguous or discontinuous with OFF periods between ON periods. The NCR may use the same beam during the periods that NCR-Fwd is ON. The NCR may use the default beam or the omnidirectional transmission and reception on the indicated time resources.

The NCR may be configured semi-statically by the BS or statically during deployment to interpret the default beam index as NCR-Fwd ON under certain conditions. For example, the default beam index may indicate NCR-Fwd ON when NCR is configured to operate in a predefined or preconfigured frequency range, e.g., in frequency range one (FR1) as specified in the 3GPP standard specifications.

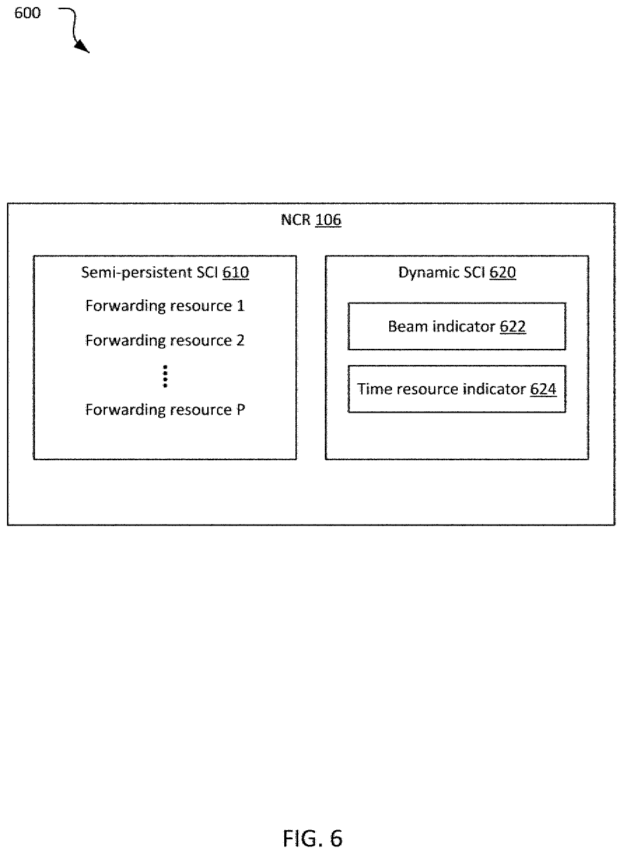

FIG. 6 illustrates a block diagram 600 in accordance with some embodiments. Block diagram 600 is an example in which the NCR 106 is configured with semi-persistent SCI 610 and receives a dynamic SCI 620. The semi-persistent SCI 610 may include forwarding resources 1-P. The forwarding resources may include semi-persistent beam information and associated time resources. The semi-persistent configuration may include a time cycle or a period when the configuration applies, and the time cycle and the associated configuration repeat periodically. For example, periodic beams may be configured with semi-persistent SCI 610. When the time resource indicator 624 of the dynamic SCI 620 indicates a time resource that is also assigned by a forwarding resource of the semi-persistent SCI 610, the NCR needs to decide and determine which configuration to be applied.

In one instance, when the NCR 106 is configured and activated with semi-persistent SCI 610 (for example, semi-persistent beam information) and then receives an aperiodic/dynamic indication 620 of the SCI on at least some of the semi-persistent time resources, the NCR 106 may be configured with one of the following alternatives.

In one alternative, implicit deactivation of semi-persistent SCI 610 is triggered, e.g., the NCR 106 may assume that the semi-persistent SCI 610 is not active anymore in the period where collision between aperiodic/dynamic indication 620 and semi-persistent configuration happens and also any following periods.

The NCR 106 deactivates all the semi-persistent SCI 610 during the period there is a collision, even the forwarding resources that do not collide with the dynamic SCI 620 in the period that collision happens and also in the following periods. The semi-persistent SCI 610 may remain deactivated until the BS reconfigures or reactivates the semi-persistent SCI 610. For example, the BS may reactivate the deactivated semi-persistent SCI 610 by reconfiguring them using RRC signaling or by explicit reactivation command.

An actual collision in transmission may not happen, and the collision may be only in scheduling, e.g., one or more time resources indicated by the dynamic SCI 620 at least partially overlap. The collision or potential collision in time resources may be referred to as scheduling collision, scheduling conflict, or conflict in time resources.

In another alternative, implicit deactivation of semi-persistent SCI 610 is triggered only during the corresponding period. For example, the NCR 106 can assume that the semi-persistent SCI 610 is no longer active when the collision between aperiodic/dynamic indication and semi-persistent configuration happens.

The NCR 106 may deactivate only the forwarding resources in semi-persistent SCI 610 that collide with the time resources indicated by the time resource indicator 624 and beam indicator 622 of the dynamic SCI 620. The forwarding resources that do not collide with the dynamic SCI 620 remain active. The deactivation may last only during the time cycle, period, or radio frame in which the NCR 106 detects the collision. Alternatively, the deactivation may last only during the time cycle, period, or radio frame in which the NCR 106 receives the dynamic SCI 620 that collides with the semi-persistent SCI 610.

In another alternative, implicit deactivation of semi-persistent SCI 610 is triggered only on the corresponding time resources, e.g., the NCR 106 can assume that the semi-persistent SCI is not active anymore, only on the time resources in the period where collision between aperiodic/dynamic indication and semi-persistent configuration happens. The semi-persistent configuration is still valid on the time resources within that period where there is no collision.

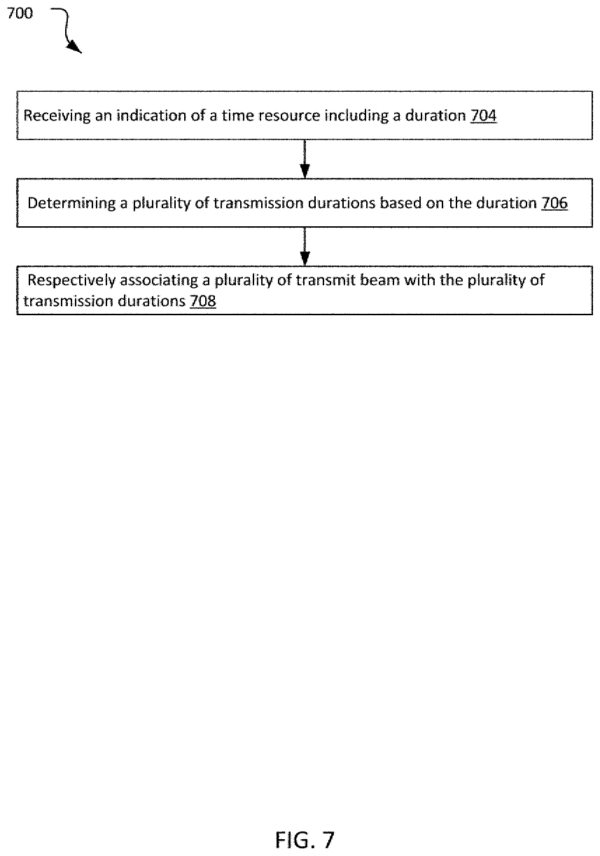

FIG. 7 illustrates an operational flow/algorithmic structure 700 in accordance with some embodiments. Operational flow/algorithmic structure 700 is an example of configuring and associating multiple beams with a single time resource. The operational flow/algorithmic structure 700 may be implemented by an NCR, for example, NRC 106, network node 1000, or components therein, e.g., processors 1004.

The operational flow/algorithmic structure 700 may include, at 704, the NCR receiving a message from the BS, e.g., a DCI. The message may indicate a time resource, and the time resource, in turn, may include a duration. For example, the BS may preconfigure the NCR with one or more time resources. The indication in the message may identify one of the preconfigured time resources. For example, the time resource may schedule a group of configured beams at the NCR to be used at a specific time and for a specific duration.

The BS may preconfigure a group of transmission beams at the NCR. The NCR may use the configured beams in NCR-Fwd functionality mode for forwarding transmission from the BS to the UE. The message NCR receives may include an indication, beam indication, that identifies a plurality of transmission beams where the plurality of transmission beams is a subset of the configured beams. For example, each configured beam may be The operational flow/algorithmic structure 700 may include, at 706, the NCR determining a plurality of transmission durations based on the duration in the received time resource. The number of transmission durations in the plurality of transmission durations may be the same as the number of transmission beams in the plurality of transmission beams.

In one alternative, all transmission durations in the plurality of transmission durations have the same value. For example, each transmission duration in the plurality of transmission durations may take a value equal to the duration in the time resource. In another example, all transmission durations have the same value in the plurality of transmission durations. The sum of their values adds to the value of the duration in the time resource.

In another alternative, transmission durations in the plurality of transmission durations may have different values. For example, the BS may configure the NCR with a formula or assign priorities to each beam. In another example, the BS may assign weights to each beam to determine the proportional relation among transmission durations of beams. The BS may preconfigure the weights semi-statically or may send them dynamically. The BS may decide the weights based on the access link channel condition. [Not in the IDF. Added by F to complete two alternatives].

The operational flow/algorithmic structure 700 may include, at 708, the NCR respectively associating the plurality of transmit beams with the plurality of transmission durations. In the respective association operation, the first beam of the plurality of transmit beams is associated with the first duration of the plurality of transmission durations, the second beam of the plurality of transmit beams is associated with the second duration of the plurality of transmission durations, etc.

The beam indication received at 704 may also determine an order for using the beams. For example, the NCR may use the beams in the order their indexes are listed in the beam indication.

The NCR may determine a plurality of contiguous time periods based on the time resource and the duration and respectively associate the plurality of transmit beams with the plurality of the contiguous time periods. The NCR may perform a downlink transmission during a period of time of the plurality of contiguous time periods using a transmit beam associated with that period of time. For example, the indicated time resource may include a slot offset or a symbol offset. The NCR uses the slot offset or the symbol offset to determine the starting time, e.g., the slot number and the symbol number. At the starting time, the NCR may use the first transmission beam in the plurality of transmission beams for forwarding on the access link. The NCR may use the first beam for a period determined by the transmission duration in the plurality of transmission durations associated with the first transmission beam.

The NCR may determine the starting time of the second transmission beam in the plurality of the transmission beam based on the starting time and transmission duration of the first beam. For example, the starting time of the second transmission beam may be immediately after the ending of the transmission duration of the first transmission beam, e.g., the starting time of the second transmission beam is equal to the starting time of the first transmission beam plus the transmission duration of the first beam.

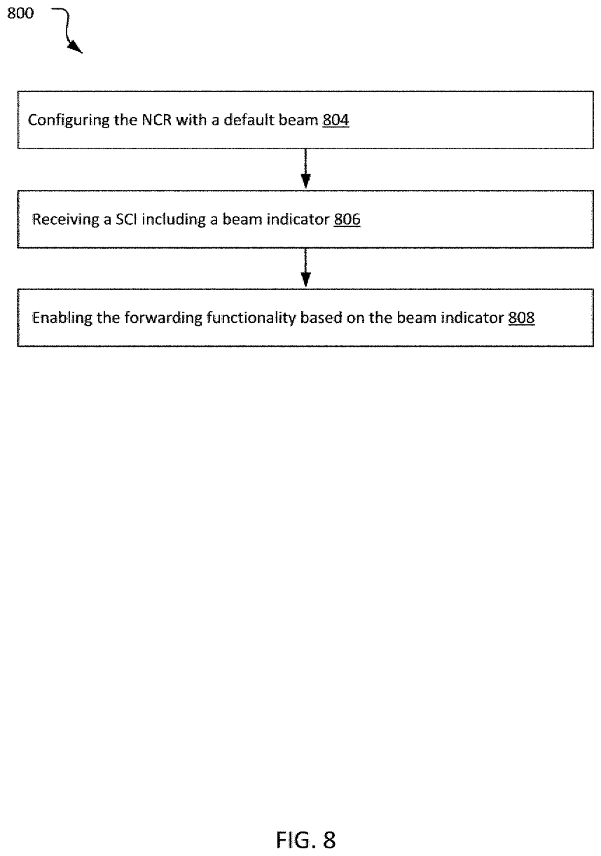

FIG. 8 illustrates an operational flow/algorithmic structure 800 in accordance with some embodiments. Operational flow/algorithmic structure 800 is an example of configuring a default beam and associating the default beam with enabling the forwarding functionality at NCR. The operational flow/algorithmic structure 800 may be implemented by an NCR, for example, NRC 106, network node 1000, or components therein, e.g., processors 1004.

The operational flow/algorithmic structure 800 may include, at 804, configuring a default beam. For example, the default beam may be configured based on a configuration message the NCR receives from a BS. The BS may transmit the configuration message to the NCR using an RRC message or signaling. The default beam may be configured during the deployment. The 3GPP specification may define the default beam. For example, the beam with the lowest index, e.g., beam index with a value of 0, may be defined to be the default beam.

The operational flow/algorithmic structure 800 may include, at 806, the NCR receiving side control information (SCI). The BS may send the SCI using a DCI on the physical downlink control channel (PDCCH) on the control link between the BS and the NCR. The NCR receives SCI on the control channel using the NCR-MT functionality. The SCI may include a beam indicator with a beam index and the beam index as the index. The beam index may be the index of the default beam. The SCI may include only one beam index. The SCI may include time resource indication associated with one or more time resources. The time resources may include slot offset, symbol offset, and duration. The NCR may use the time resources to determine the starting time and duration associated with the beams indicated by the beam indicator.

The operational flow/algorithmic structure 800 may include, at 808, the NCR enabling forwarding functionality based on the beam indicator of the SCI. For example, when the beam indicator includes only the beam index of the default beam, the NCR may interpret the beam indicator as an indication to enable or turn the ON signal of the forwarding function. The NCR may be configured as default to have the forwarding functionality, e.g., NCR-Fwd, disabled, or OFF.

The NCR may enable or set forwarding functionality ON at all of the time resources associated with the default beam. Alternatively, the NCR may enable the forwarding functionality for all the times after receiving the beam indication with the default beam index.

After the forwarding is enabled, the following SCI with a beam indicator having the default beam index may toggle and disable or turnOFF the forwarding functionality. The BS may send a semi-static SCI with an indication of the default beam or a dynamic SCI with an indication of the default beam.

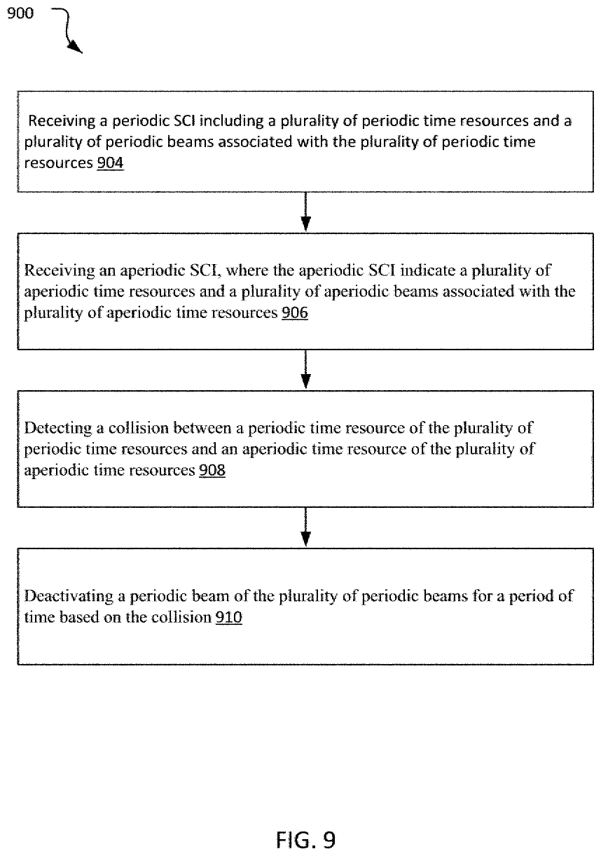

FIG. 9 illustrates an operational flow/algorithmic structure 900 in accordance with some embodiments. Operational flow/algorithmic structure 900 is an example of resolving a collision between periodic and aperiodic beams. The operational flow/algorithmic structure 800 may be implemented by an NCR, for example, NRC 106, network node 1000, or components therein, e.g., processors 1004.

The operational flow/algorithmic structure 900 may include, at 904, the NCR receiving a periodic SCI that includes a plurality of periodic time resources and a plurality of periodic beams associated with the plurality of periodic time resources. The periodic time resources determine time intervals, e.g., a starting time and a duration. For example, a time resource may determine a beginning time T and a duration D in a radio frame. The time resources in a periodic SCI may span a single radio frame or multiple radio frames. At a periodic time resource, the NCR may use the periodic beam associated with that periodic time resource for forwarding transmission from the BS to the UE. The NCR may receive periodic SCI through RRC messages or signaling. The periodic SCI may be called semi-persistent SCI, and the associated beams may be called semi-persistent beams.

The periodic SCI may include a time cycle or a period that determines the periodicity and repeating pattern of using periodic beams. For example, a periodic SCI may determine a time resource T of D symbols starting at symbol S of slot L, e.g., symbols S in slot L to symbol S+D, which may be in slot M. Slot M may be the same as slot L or maybe another slot. The periodic SCI may assign a beam B to the time resource T. The time cycle or periodicity P determines the repeating pattern of association of beam B to time resource T. For example, the time cycle P may be in number of slots, and then the NCR associated B with time resource T₁ where T₁ begins at symbol S of slot L+P. In another example, time resource Ty may start at symbols S of slot M+P. The SCI also associates beam B with time resource T₁. The pattern can repeat, e.g., the SCI associates beam B to time resources Tₖ where Tₖ begins at symbol S of slot L+k·P for k∈{0, 1, 2, . . . }.

The operational flow/algorithmic structure 900 may include, at 906, the NCR receiving an aperiodic SCI, e.g., a dynamic SCI via DCI. The SCI indicates a plurality of aperiodic time resources and a plurality of aperiodic beams associated with the plurality of aperiodic time resources. The aperiodic time resource determines time intervals, e.g., a starting time and a duration. The NCR may use the aperiodic beam associated with that aperiodic time resource for forwarding transmission from the BS to the UE at a given aperiodic time resource.

The operational flow/algorithmic structure 900 may include, at 908, the NCR detecting a collision between a periodic time resource and an aperiodic time resource. It means that the time interval determined by the periodic time resource may entirely or partially overlap with the time interval determined by the aperiodic time resource. The collision may cause ambiguity in NCR behavior. For example, without resolving the collision, it is not clear whether the NCR should use the periodic beam or the aperiodic beam for forwarding during the overlapping time.

The operational flow/algorithmic structure 900 may include, at 910, the NCR deactivating the periodic beam of the plurality of periodic beams for a period of time, where the period of time is based on the detection of the collision. The NCR may only deactivate the periodic beam associated with the collided periodic time resource. Alternatively, the NCR may deactivate all the periodic beams in the plurality of periodic beams indicated or configured by the periodic SCI.

Upon detection of a collision, the NCR may deactivate the periodic beam or the plurality of the periodic beams only in the time cycle in which the collision occurred. For example, if the collision between periodic and periodic SCIs occurs during the j^{th} time cycle of the periodic time resources, the periodic beam or all the periodic beams are deactivated only during the j^{th} period. In the following period or time cycle, e.g., the j+1^{st} cycle, the NCR may use periodic beams based on their schedule in association with the periodic time resources.

Alternatively, the NCR may deactivate the periodic beam associated with the collided periodic time resource or all the periodic beams upon detecting a collision. The periodic beam or beams may remain deactivated until the NCR receives a new configuration, a reconfiguration of the periodic beams, or an activation indication from the BS.

The NCR may be configured with the priority order of beam indication. The configuration may define the priority order of the beam indications or enable or disable the deactivation of the beam indications with lower priority. For example, RRC signaling may define the priority order of beam indicators. The priority order of the beam indications may be defined in 3GPP standard specifications.

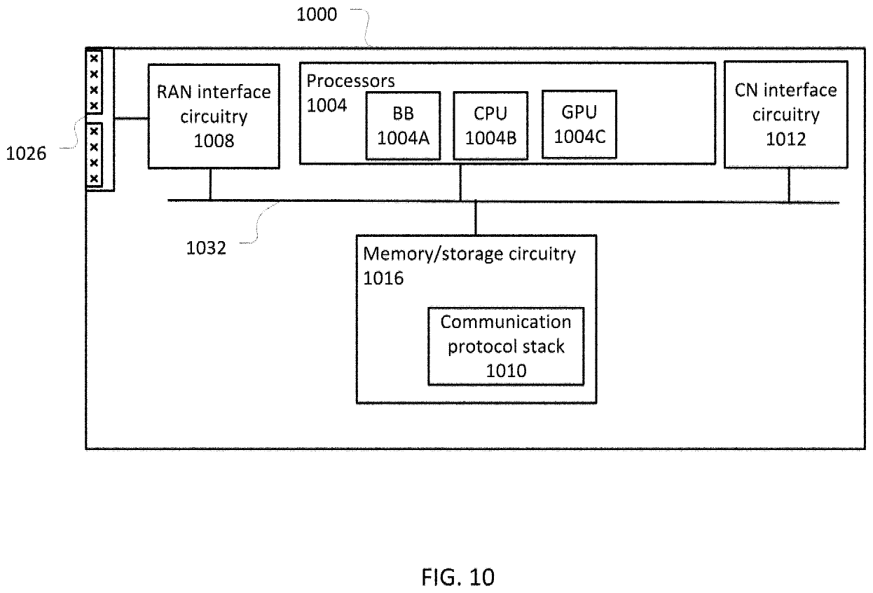

FIG. 10 illustrates a network node 1000 in accordance with some embodiments. The network node 1000 may be similar to and substantially interchangeable with base station 108, a device implementing one of the network hops, an integrated access and backhaul (IAB) node, a network-controlled repeater (NCR), or a server in a core network or external data network.

The network node 1000 may include processors 1004, RF interface circuitry 1008 (if implemented as an access node), the core node (CN) interface circuitry 1012, memory/storage circuitry 1016, and antenna structure 1026.

The components of the network node 1000 may be coupled with various other components over one or more interconnects 1032.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform operations as described herein.

In some embodiments, the baseband processor circuitry 1004A may access a communication protocol stack 1036 in the memory/storage 1012 to communicate over a 3GPP-compatible network. In general, the baseband processor circuitry 1004A may access the communication protocol stack 1036 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on the cyclic prefix OFDM (CP-OFDM) in the uplink or downlink and discrete Fourier transform spread OFDM (DFT-S-OFDM) in the uplink.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 1026 and proceed to filter and amplify (with a low-noise amplifier) the signal. The signal may be provided to a receiver of the transceiver that down-converts the RF signal into a baseband signal that is provided to the baseband processor of the processor 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The memory/storage 1012 (including communication protocol stack 1010) may include one or more non-transitory, computer-readable media that includes instructions (for example, the communication protocol stack 1036) that may be executed by one or more of the processors 1004 to cause the UE 1000 to perform various operations described herein. The memory/storage 1012 includes any type of volatile or non-volatile memory that may be distributed throughout the UE 1000. In some embodiments, some of the memory/storage 1012 may be located on the processors 1004 themselves (for example, L1 and L2 cache), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read-only memory (EPROM), electrically erasable programmable read-only memory (EEPROM), Flash memory, solid-state memory, or any other type of memory device technology.

The antenna structure 1026 may include antenna elements to convert electrical signals into radio waves to travel through the air and convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands, including bands in FR1 or FR2.

The processors 1004 may perform operations associated with scheduling beams at an NCR as described elsewhere herein. For example, the processors 1004 may receive a timer resource and a plurality of beams and associate the plurality of beams to time intervals where the duration of each time interval is based on a duration parameter in the received time resource.

The CN interface circuitry 1012 may provide connectivity to a core network, for example, a 5th Generation Core network (5GC) using a 5GC-compatible network interface protocol such as carrier Ethernet protocols or some other suitable protocol. Network connectivity may be provided to/from the network node 1000 via a fiber optic or wireless backhaul. The CN interface circuitry 1012 may include one or more dedicated processors or FPGAs to communicate using one or more of the aforementioned protocols. In some implementations, the CN interface circuitry 1012 may include multiple controllers to provide connectivity to other networks using the same or different protocols.

In some embodiments, the network node 1000 may be coupled with transmit-receive points (TRPs) using the antenna structure 1026, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry, as described above in connection with one or more of the preceding figures, may be configured to operate in accordance with one or more of the examples set forth below. For another example, circuitry associated with a UE, base station, network element, etc., as described above in connection with one or more of the preceding figures, may be configured to operate in accordance with one or more of the examples set forth below in the example section.

### EXAMPLES

In the following sections, further exemplary aspects are provided.

Example 1 includes a method for forwarding transmission at a network-controlled repeater (NCR), the method comprising: receiving downlink control information (DCI) that indicates a plurality of transmit beams and a time resource that includes a duration; determining a plurality of transmission durations based on the duration; and respectively associating the plurality of transmit beams with the plurality of transmission durations.

Example 2 includes the method of example 1 or some other examples herein, the method further including: receiving a message to configure a plurality of time resources including the time resource.

Example 3 includes the method of examples 1 or 2 or some other examples herein, wherein a first transmit beam of the plurality of transmit beams is associated with a first transmission duration of the plurality of transmission durations, the time resource further includes a slot offset or a symbol offset, and the method further comprises: determining a starting time of the first transmission duration based on the slot offset or the symbol offset; and configuring a transmitter to use the first transmit beam at the starting time for a period of time equal to the first transmission duration.

Example 4 includes the method of examples 1-3 or some other examples herein, wherein the starting time is a first starting time, the period of time is a first period of time, a second transmit beam of the plurality of transmit beams is associated with a second transmission duration of the plurality of transmission durations, and the method further comprises: determining a second starting time based on the first starting time and the first transmission duration; configuring the transmitter to use the second transmit beam at the second starting time for a second period of time equal to the second transmission duration associated with the second transmit beam.

Example 5 includes the method of examples 1-4 or some other examples herein, wherein the first transmission duration is equal to the second transmission duration.

Example 6 includes the method of examples 1-5 or some other examples herein, wherein the first transmission duration is equal to the duration.

Example 7 includes the method of examples 1-6 or some other examples herein, wherein a sum of all transmission durations in the plurality of transmission durations is equal to the duration.

Example 8 includes the method of examples 1-7 or some other examples herein, further including: determining a plurality of contiguous time periods based on the time resource and the duration; respectively associating the plurality of transmit beams with the plurality of contiguous time periods; and performing, during a first time period of the plurality of contiguous time periods, a downlink transmission using a first transmit beam that is associated with the first time period.

Example 9 includes the method of examples 1-8 or some other examples herein, wherein the DCI includes a plurality of beam indexes in one or more fields to indicate the plurality of transmit beams.

Example 10 includes the method of examples 1-9 or some other examples herein, wherein the DCI comprises side control information (SCI) to indicate the plurality of transmit beams and the time resource.

Example 11 includes a method for enabling a forwarding functionality of a network-controller repeater (NCR), the method comprising: receiving side control information (SCI) including a beam indicator; and enabling the forwarding functionality of the NCR for a period of time based on the beam indicator, wherein the forwarding functionality is to include receiving a transmission from a base station and transmitting the transmission to a user equipment.

Example 12 includes the method of example 11 or some other examples herein, the method further including: receiving a message to configure a default beam.

Example 13 includes the method of examples 11 or 12 or some other examples herein, wherein the beam indicator indicates a preconfigured default beam.

Example 14 includes the method of examples 11-13 or some other examples herein, wherein the default beam is a beam with a smallest beam index.

Example 15 includes the method of examples 11-14 or some other examples herein, wherein the SCI is to indicate a plurality of time resources, the period of time is based on the plurality of time resources, and the method further including: setting a transmission beam used for the forwarding functionality to be the preconfigured default beam or an omnidirectional beam.

Example 16 includes a method for prioritizing beam indications at network-controlled repeaters (NCR), the method comprising: receiving, by the NCR, periodic side control information (SCI), the periodic SCI is to indicate a plurality of periodic time resources and a plurality of periodic beams respectively associated with the plurality of periodic time resources; receiving, by the NCR, an aperiodic SCI, the aperiodic SCI is to indicate a plurality of aperiodic beams and a plurality of aperiodic time resources respectively associated with the plurality of aperiodic beams; detecting a resource conflict between a periodic time resource of the plurality of periodic time resources and an aperiodic time resource of the plurality of aperiodic time resources; and deactivating a periodic beam of the plurality of periodic beams for a period of time based on the resource conflict.

Example 17 includes the method of example 16 or some other examples herein, wherein the periodic beam is associated with the periodic time resource.

Example 18 includes the method of examples 16 and 17 or some other examples herein, wherein the periodic SCI is to include a time cycle, and the period of time is based on the time cycle.

Example 19 includes the method of examples 16-18 or some other examples herein, the method further including: receiving a message to enable or configure the deactivation.

Example 20 includes the method of examples 16-19 or some other examples herein, further including: receiving a configuration to reactivate the periodic beam or to reconfigure the periodic SCI.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example includes a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of aspects to the precise form disclosed. Modifications and variations are possible in light of the above teachings or may be acquired from the practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-20. (canceled)

21. A method comprising:
receiving, at a network-controlled repeater (NCR), a first side control information (SCI), the first SCI to indicate a plurality of periodic or semi-persistent time resources and a plurality of periodic or semi-persistent beams respectively associated with the plurality of periodic or semi-persistent time resources;
receiving, at the NCR, a second SCI, the second SCI to indicate a plurality of aperiodic beams and a plurality of aperiodic time resources respectively associated with the plurality of aperiodic beams;
detecting a resource conflict between a first periodic or semi-persistent time resource of the plurality of periodic or semi-persistent time resources and a first aperiodic time resource of the plurality of aperiodic time resources; and
deactivating a first periodic or semi-persistent beam of the plurality of periodic or semi-persistent beams for a period of time based on the resource conflict.

22. The method of claim 21, wherein the first periodic or semi-persistent beam is associated with the first periodic or semi-persistent time resource.

23. The method of claim 21, wherein the period of time is within a time cycle configured by the first SCI and wherein forwarding resources configured by the first SCI that are within the time cycle and outside of the period of time remain active.

24. The method of claim 21, further comprising:
receiving a message to enable or configure said deactivating.

25. The method of claim 21, wherein the period of time corresponds to a set of symbols in the first periodic or semi-persistent time resource that collide with the first aperiodic time resource.

26. The method of claim 21, further comprising applying the first aperiodic beam for a transmission in the first aperiodic time resource.

27. An apparatus comprising:
processor circuitry to:
receive, at a network-controlled repeater, a downlink control information (DCI) that indicates a plurality of transmit beams and a time resource that includes a duration;
determine a plurality of transmission durations based on the duration; and
respectively associate the plurality of transmit beams with the plurality of transmission durations for a forwarding functionality of the NCR; and
interface circuitry coupled to the processor circuitry to enable communication.

28. The apparatus of claim 27, wherein the processor circuitry is further to:
receive a message to configure a plurality of time resources including the time resource.

29. The apparatus of claim 27, wherein a first transmit beam of the plurality of transmit beams is associated with a first transmission duration of the plurality of transmission durations, the time resource further includes a slot offset or a symbol offset, and the processor circuitry is further to:
determine a starting time of the first transmission duration based on the slot offset or the symbol offset; and
configure a transmitter to use the first transmit beam at the starting time for a period of time equal to the first transmission duration.

30. The apparatus of claim 29, wherein the starting time is a first starting time, the period of time is a first period of time, a second transmit beam of the plurality of transmit beams is associated with a second transmission duration of the plurality of transmission durations, and the processor circuitry is further to:
determine a second starting time based on the first starting time and the first transmission duration; and
configure the transmitter to use the second transmit beam at the second starting time for a second period of time equal to the second transmission duration associated with the second transmit beam.

31. The apparatus of claim 30, wherein the first transmission duration is equal to the second transmission duration.

32. The apparatus of claim 27, wherein a sum of all transmission durations in the plurality of transmission durations is equal to the duration.

33. The apparatus of claim 27, wherein the processor circuitry is further to:
determine a plurality of contiguous time periods based on the time resource and the duration;
respectively associate the plurality of transmit beams with the plurality of contiguous time periods; and
perform, during a first time period of the plurality of contiguous time periods, a downlink transmission using a first transmit beam that is associated with the first time period.

34. The apparatus of claim 27, wherein the DCI includes a plurality of beam indexes in one or more fields to indicate the plurality of transmit beams.

35. The apparatus of claim 27, wherein the DCI comprises side control information (SCI) to indicate the plurality of transmit beams and the time resource.

36. One or more non-transitory, computer-readable media having instructions that, when executed, cause one or more processors to:
receive, at a network-controlled repeater (NCR), side control information (SCI) including a beam indicator; and
enable a forwarding functionality of the NCR for a period of time based on the beam indicator, wherein the forwarding functionality is to include receiving a transmission from a base station and transmitting the transmission to a user equipment.

37. The one or more non-transitory, computer-readable media of claim 36, wherein the instructions, when executed, further cause the processor circuitry to:
receive a message to configure a default beam.

38. The one or more non-transitory, computer-readable media of claim 37, wherein the beam indicator indicates the default beam.

39. The one or more non-transitory, computer-readable media of claim 38, wherein the SCI is to indicate a plurality of time resources, the period of time is based on the plurality of time resources, and wherein the instructions, when executed, further cause the processor circuitry to:
set a transmission beam used for the forwarding functionality to be the default beam or an omnidirectional beam.

40. The one or more non-transitory, computer-readable media of claim 37, wherein the default beam is a beam with a smallest beam index.
